(19) United States
(12) Patent Application Publication
(10) Pub. No.: US 2015/0351420 A1
(43) Pub. Date: Dec. 10, 2015

(54) FOAMING AID AND PROCESS OF ITS PRODUCTION

(71) Applicant: NESTEC S.A., Vevey (CH)

(72) Inventors: Federico Mora, Morges (CH); Eric Dossin, Jougne (FR); Philippe Montavon, Echichens (CH); Valerie Martine Jeanine Leloup, Orbe (CH); Imre Blank, Savigny (CH); Thomas Hofmann, Freising (DE); Peter Kornas, Muhldorf am Inn (DE)

(21) Appl. No.: 14/758,015

(22) PCT Filed: Dec. 23, 2013
(86) PCT No.: PCT/EP2013/077881

§ 371 Date: Jun. 26, 2015

(30) Foreign Application Priority Data
Dec. 28, 2012 (EP) 12199583.1

(51) Int. Cl. A23F 5/40; A23F 5/02; B65D 85/804; A23L 1/00

(52) U.S. Cl. CPC A23F 5/40; A23L 1/0097; A23F 5/02; B65D 85/8043; A23V 2002/00

(57) ABSTRACT

The present invention relates to a process of making a foaming aid comprising the steps of: (i) providing a composition comprising at least two 4-vinylcatechol monomers, (ii) inducing polymerization of the 4-vinylcatechol monomers of step (i) to obtain a composition comprising polyfunctional phenols.

### FIELD OF THE INVENTION

The present invention relates to processes of preparing a foaming aid. In particular the present invention relates to processes of preparing a foaming aid for use in a beverage, such as a coffee product, to generate a stable espresso-type foam or crema, e.g. upon reconstitution. The present invention further relates to a foaming aid as such, coffee products obtained comprising said foaming aid and for containers comprising said coffee products.

### BACKGROUND OF THE INVENTION

In coffee, in particular espresso coffees, persistent foam also referred to as “crema” represents a visual quality criterion. The volume, texture, finesse, color and stability of the crema are distinctive characteristics appealing to the consumer. Crema results from the extraction of surface active coffee components that coat and stabilize the gas bubbles created by blasting the tamped espresso coffee matrix with pressurized heated water.

The development of a soluble coffee delivering espresso-type crema upon reconstitution would definitively represent a competitive advantage in the field of coffee beverage production. The scientific and technical challenges are considerable since the soluble coffee composition and the preparation of the same are quite different from e.g. espresso extraction.

In EP 0 839 457 a process is disclosed for making an instant coffee, particularly a spray-dried instant coffee, which, when contacted with hot water, produces a foam which simulates espresso crema. As part of the soluble “espresso” coffee generation process, foam formation process, the extract is foamed by pressurized gas injection, homogenizing the foamed extract to reduce gas bubble size, and spray dried under sufficient drier outlet temperature and spray pressure conditions to obtain porous particles with gas bubbles incorporated therein. The incorporation of minute size gas bubbles is essential for the delivery of an improved in-cup foam in accordance with EP 0 839 457.

Thus, there is a need in the industry to provide compounds that are capable of improving foam volume and foam appearance in a beverage, such as a coffee beverage, which thereby meets the increasing demands from the consumer in respect of quality and pleasure during consumption.

### SUMMARY OF THE INVENTION

Accordingly, the present invention relates to a class of compounds derived from non-roasted coffee phenolic acids and process modified coffee phenolic acids that are associated with an increased foam volume for liquid or powdered products with foaming properties.

Hence, it is an object of the present invention to provide a process of making a foaming aid comprising the steps of:
(i) providing a composition comprising at least two 4-vinylcatechol monomers,
(ii) inducing polymerization of the 4-vinylcatechol monomers of step (i) to obtain a composition comprising polyfunctional phenols.

In another object the present invention relates to a foaming aid obtainable by the process according to the present invention.

In a further object the present invention relates to the use of a foaming aid of the present invention as a coffee foaming aid.

It is yet another object the present invention relates to a process of making a coffee product comprising the steps of:
(a) providing a coffee extract,
(b) adding a foaming aid according to any of the preceding claims to said extract.

Furthermore, an object of the present invention relates to a coffee product comprising a foaming agent obtainable by the process according to any of the preceding claims.

In an even further object the present invention relates to a container comprising the coffee product according to the present invention.

### BRIEF DESCRIPTION OF THE DRAWINGS

FIG. 1 shows some process induced polyfunctional phenolics 16-25 derived from condensation of 4-vinylcatechol monomers (15).

FIG. 2 shows foam volume determined by FMD (Foam Measuring Device) as a function of time for reference coffee (grey squares) and for reference coffee spiked with 0.065% rCA, roasted caffeic acid (dark circles).

FIG. 3 shows foam volume determined by Ultratrax as a function of time for Arabica 1.1 coffee green coffee beans spiked with a) 0% caffeic acid (black circles), b) 0.25% caffeic acid (dark cross), c) 0.5% caffeic acid (grey triangle), d) 1% caffeic acid (grey squares) and e) 2% caffeic acid (grey circles) and roasted at 236° C. for 720 s.

FIG. 4 shows the foam volume determined by KOMO for untreated coffee beans, coffee beans soaked in water, coffee beans soaked in caffeic acid solution and coffee beans soaked in caffeic acid-enriched green coffee extract.

### DETAILED DISCLOSURE OF THE INVENTION

As mentioned earlier the foam (or crema) of coffee represents a quality criterion. Different parameters may be used as the distinctive characteristic, or the distinctive characteristics, of the crema. Such distinctive characteristics may be volume, texture finesse, colour and stability. Of cause these distinctive characteristics may be more or less correlated.

In addition coffee foam has shown to have a very strong antioxidant activity. This activity is believed to be directly associated with coffee phenolic acids which also contribute to foam structure.

Thus, these phenolic compounds may be termed polyfunctional phenolics due to their dual activity (as foaming aid and as antioxidant activity) and categorized into two main families:
Naturally occurring green coffee phenolic acids also known as chlorogenic acids, and
Process induced polymerisation of polyfunctional phenolics. The process hereby may be a thermal, a chemical, an oxidative or enzymatic treatment.

The inventors of the present invention found that compounds (polymerized compounds) comprising at least two 4-vinylcatechol monomers may act as a foaming aid.

In the present context the term “foaming aid” relates to an agent that can be added to a foaming substance to improve its foaming properties. This foaming substance in the present invention may preferably refer to a coffee beverage for example an instant coffee beverage. The determination of the “improved foaming properties” may be seen from an increasing foam volume, which also has an indirect influence on foam texture, foam color and foam stability.

The term “4-vinylcatechol monomers” relates to polyphenol compounds having special functionalities, in particular in respect of acting as a foaming agent. It is believed that the polyphenol compounds may act as crosslinking agents through a multiple range of interaction (i.e. covalent interaction, ionic interaction, hydrogen binding, dipole-dipole interaction) with other compounds, such as other coffee compounds, resulting in enhanced foam volume.

In the context of the present invention, “polyphenols” refers to a structural class of natural, synthetic, and semisynthetic organic chemicals characterized by the presence of multiples of phenol units (two or more phenol units). The number and characteristics of these phenol substructures underlie the unique physical, chemical, and biological properties of particular members of the class.

Thus, it is an embodiment of the present invention to provide a process of making a foaming aid comprising the steps of
(i) providing a composition comprising at least two 4-vinylcatechol monomers,
(ii) inducing polymerization of the 4-vinylcatechol monomers of step (i) to obtain a composition comprising polyfunctional phenols.

In an embodiment of the present invention the composition in step (i) comprise at least three 4-vinylcatehol monomers; e.g. at least four 4-vinylcatehol monomers, such as at least five 4-vinylcatehol monomers; e.g. at least six 4-vinylcatehol monomers, such as at least seven 4-vinylcatehol monomers.

The polymerisation induced in step (ii) may be addition polymerisation, in which molecules of monomer are simply added together; or condensation polymerisation, in which monomer molecules combine with loss of simple molecules, e.g. like water. It may be preferred that the polymerisation induced in step (ii) is a condensation polymerisation.

In an embodiment of the present invention the 4-vinylchatechol monomers may be derived from caffeic acid. More specifically, the 4-vinylcatechol monomers may preferably be derived from at least one chlorogenic acid.

The at least one chlorogenic acid may be selected from the list consisting of 3-caffeoyl quinic acid (1), 4-caffeoyl quinic acid (2), 5-caffeoyl quinic acid (3), 3,4-dicaffeoyl quinic acid (7), 3,5-dicaffeoyl quinic acid (8), 4,5-dicaffeoyl quinic acid (9).

Preferably the at least two 4-vinylcatechol monomers are obtained by decarboxylation of caffeic acid or the caffeic acid moiety of chlorogenic acids.

Furthermore, the caffeic acid may be obtained by hydrolysis of said chlorogenic acid. Said hydrolysis of said chlorogenic acid may be obtained by heat treatment.

The 4-vinylchatechol monomers may be synthetically produced, produced by fermentation or derived from a plant material, such as coffee. Preferably, the 4-vinylchatechol monomers may be obtained from coffee.

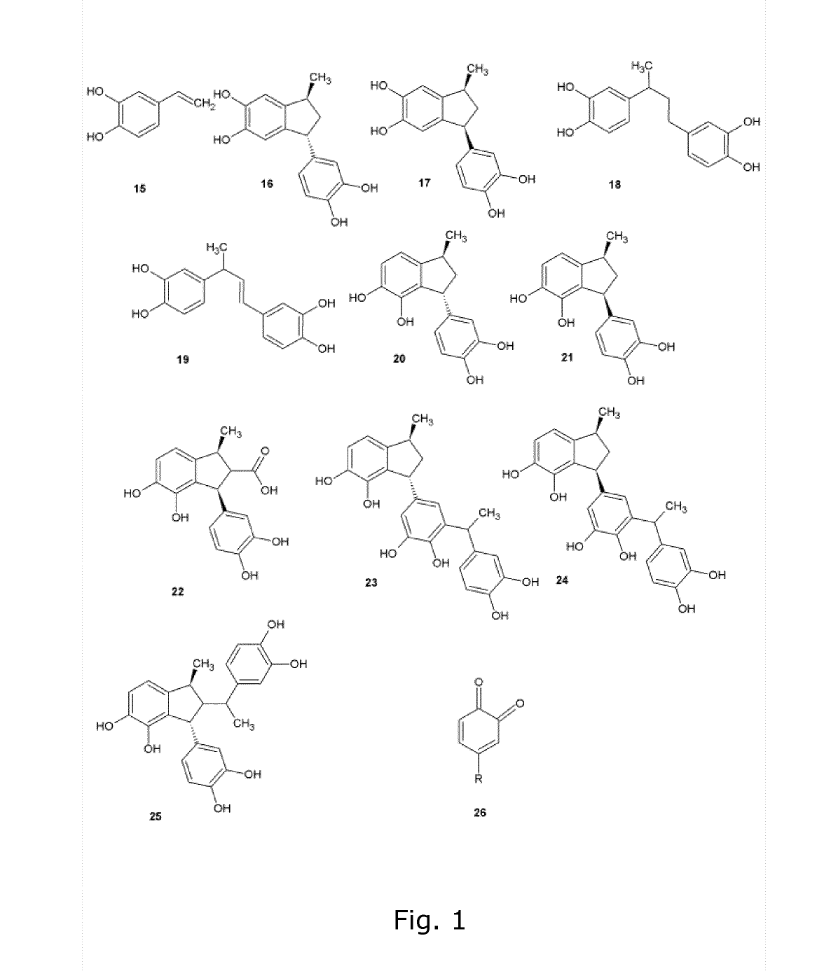

The 4-vinylchatechol monomers used according to the present invention has the structural formula depicted in (15) in FIG. 1. Some polyfunctional phenolics (16)-(25), as well as quinones (26), may be derived from polymerisation of 4-vinylchatechol monomers. The compounds presented in FIG. 1 is in no way exhaustive or limiting to the scope of the present invention.

These polyfunctional phenolics are characterized by the presence of at least two phenolic moieties from the condensation of at least two 4-vinylcatechol (15) monomers. As in the case of naturally occurring green coffee phenolic acids, they exhibit antioxidant activities and participate in foam structure and stability. The antioxidant properties are related to their ability to quench free radicals, quench reactive oxygen species or chelate metal ions responsible for free radical formation. The foam structure formation properties may be related to the ability of these compounds to interact with the coffee matrix through hydrogen bonding interactions, hydrophobic interactions, pi-stacking, electrostatic interactions, or covalent linkage. These compounds, under certain conditions can also interact with naturally occurring nucleophiles such as amino acid side chains on proteins and sugars present in the coffee matrix thus being integrated in melanoidines as covalently linked phenyl propanoid species. If these interactions occur within the complex multiphase colloidal system of coffee foam, they may lead to a further stabilization of the latter resulting from a thickening behaviour of the foam. It has also been demonstrated that this family of compounds also leads to the formation of oxygen micro bubbles within the coffee matrix. The micro bubbles produced from complex redox reactions, that are naturally present in coffee but accelerated in the presence of this family of compounds, may also lead to the formation of stable foam.

In an embodiment of the present invention the composition comprising polyfunctional phenols of step (ii) is a composition comprising at least one polyhydroxylated phenylindane.

In a further embodiment of the present invention said composition comprising polyfunctional phenols of step (ii) is a composition comprising at least one multiply hydroxylated phenylindane selected from the list consisting of trans-5,6-Dihydroxy-1-methyl-3-(3′-4′-dihydroxyphenyl) indane, cis-5,6-Dihydroxy-1-methyl-3-(3′-4′-dihydroxyphenyl) indane, 1,3-bis(3′-4′-dihydroxyphenyl)butane, trans-1,3-bis(3′-4′-dihydroxyphenyl)butene, 5,6-Dihydroxy-2-carboxy-1-methyl-3-(3′-4′-dihydroxyphenyl) indane, trans-4,5-dihydroxy-1-methyl-3-(3′,4′-dihydroxyphenyl) indane, cis-4,5-dihydroxy-1-methyl-3-(3′,4′-dihydroxyphenyl) indane, trans-5,6-dihydroxy-1-methyl-3-[3′,4′-dihydroxy-5′-(1-(3″,4″-dihydroxyphenyl)-1-ethyl)phenyl]indane, cis-5,6-dihydroxy-1-methyl-3-[3′,4′-dihydroxy-5′-(1-(3″,4″-dihydroxyphenyl)-1-ethyl)phenyl]indane, 5,6-dihydroxy-1-methyl-2-[1-(3′,4′-dihydroxyphenyl)-1-ethyl]-3-(3″,4″-dihydroxyphenyl) indane.

In yet an embodiment of the present invention the composition comprising polyfunctional phenols of step (ii) may be a composition comprising trans-5,6-Dihydroxy-1-methyl-3-(3′-4′-dihydroxyphenyl) indane, cis-5,6-Dihydroxy-1-methyl-3-(3′-4′-dihydroxyphenyl) indane, trans-1,3-bis(3′-4′-dihydroxyphenyl)butene.

In yet a further embodiment of the present invention said composition comprising polyfunctional phenols of step (ii) is a composition comprising trans-5,6-Dihydroxy-1-methyl-3-(3′-4′-dihydroxyphenyl) indane, cis-5,6-Dihydroxy-1-methyl-3-(3′-4′-dihydroxyphenyl) indane.

As mentioned earlier the phenolic compounds may be categorised into a group of process induced polymerisation of polyfunctional phenolics. This process may be a thermal treatment, a chemical treatment, an oxidative treatment or an enzymatic treatment. Preferably, the process may be a thermal treatment (see e.g. Richard H. Stadler, Dieter H. Welti, Andreas A. Stämpfli, and Laurent B. Fay, J. Agric. Food Chem. 1996, 44, 898-905, included herein by reference).

Thermally induced polyfunctional phenolics may be defined as compounds derived from the condensation of 4-vinylcatechol monomers released from free caffeic acid or 5-caffeoyl quinic acid e.g. upon roasting. The condensation of these monomers gives rise to a multiplicity of reaction products that can be classified as multiply hydroxylated phenylindanes

Hence, the polymerization in step (ii) may be induced by heat treatment.

The process induced polymerisation of polyfunctional phenolics may also involve chemical treatment of the 4-vinylcatechol monomers. Chemically induced polyfunctional phenolics may be defined as compounds derived from thermally induced polyfunctional phenolics or from naturally occurring green coffee phenolic acids that have been treated with an alkaline material such as potassium hydroxide or sodium hydroxide. Catechol moieties may react with an alkaline solution in the presence of oxygen to yield quinones (26). Quinones have an electrophilic character, meaning that they can easily undergo nucleophilic additions, namely conjugated additions with naturally occurring nucleophiles such as amino acid side chains on proteins, other phenolic compounds and sugars present in the coffee matrix. These reactions may also lead to the formation of chemically induced polyfunctional phenolics and if they occur within the complex multiphase colloidal system of coffee foam. The chemically induced polyfunctional phenolics may lead to a stabilization of the foam resulting from a thickening behavior of the system.

In an embodiment the process of the present invention may further comprising a step of treating said composition comprising polyfunctional phenols of step (ii) with an alkali. Preferably, said alkali is potassium hydroxide.

The process induced polymerisation of polyfunctional phenolics may also involve an oxidative treatment. Oxidatively induced polyfunctional phenolics are defined as compounds derived from thermally induced polyfunctional phenolics or from naturally occurring green coffee phenolic acids that have been oxidized to yield quinones (26). The oxidatively induced polyfunctional phenolics acts and behaves as in the case of chemically induced polyfunctional phenolics.

Thus, in an embodiment the process of the present invention may further comprising a step of oxidizing the composition obtained in step (ii).

The process induced polymerisation of polyfunctional phenolics may also involve an enzymatic treatment. Enzymatically induced polyfunctional phenolics are defined as compounds derived from thermally induced polyfunctional phenolics or from naturally occurring green coffee phenolic acids that have been treated with enzymes, such as polyphenol oxidase, laccase or tyrosinase converting them into quinones (26). The enzymatically induced polyfunctional phenolics acts and behaves as in the case of chemically induced polyfunctional phenolics.

In an embodiment of the present invention the composition obtained in step (ii) may be treated with an enzyme that forms quinones from said polyphenol.

Preferably, said enzyme is selected from the list consisting of polyphenol oxidase, laccase and tyrosinase.

The foaming aid provided according to the present invention may be used as a foaming aid for liquid or powdered products. In particular, the foaming aid provided according to the present invention may be used as a foaming aid for a beverage, in particular a coffee beverage.

The present invention also relates to the provision of a process of making a coffee product comprising the steps of:
(a) providing a coffee extract,
(b) adding a foaming aid according to the present invention to said extract.

In an embodiment of the present invention the foaming aid may be added when the coffee extract is in a liquid form or when the coffee extract is in a dry form.

In an embodiment the process according to the present invention further comprising at least one step of concentrating said coffee extract. This at least one step of concentrating said coffee extract may be a step of evaporation.

In an embodiment the present invention may involve a further step of drying said coffee extract to obtain a moisture content of 4% (w/w %) or below.

Said foaming aid may be added prior to drying said coffee extract and/or said foaming aid may be added after drying said coffee extract.

The coffee product may be a soluble coffee product. Preferably said coffee product is in the form of a water-soluble powder or granulates, which may be reconstituted in a liquid. Alternatively, said coffee product may be in a liquid form.

The coffee extracts may be obtained by any processes available for the skilled person. However, it may be preferred that the coffee extract is obtained by hot extraction. Preferably, step (b) is performed after said hot extraction.

The material used for providing the coffee extract may be a coffee extract of green coffee beans, roasted coffee beans or a mixture thereof.

In an embodiment of the present invention the coffee product is a coffee product selected from the list consisting of instant coffee, instant espresso coffee, liquid coffee concentrate and coffee mixes, coffee mixtures, R&G coffee (roasted & ground coffee) with or without capsules, mixes of R&G and instant coffee, ready-to-drink coffee beverages,

In yet an embodiment of the present invention the foaming aid comprises trans-5,6-Dihydroxy-1-methyl-3-(3′-4′-dihydroxyphenyl) indane, cis-5,6-Dihydroxy-1-methyl-3-(3′-4′-dihydroxyphenyl) indane, and/or trans-1,3-bis(3′-4′-dihydroxyphenyl)butene. Preferably, the total concentration of trans-5,6-Dihydroxy-1-methyl-3-(3′-4′-dihydroxyphenyl) indane, cis-5,6-Dihydroxy-1-methyl-3-(3′-4′-dihydroxyphenyl) indane, and/or trans-1,3-bis(3′-4′-dihydroxyphenyl)butane in the coffee product is above 2.3 mg/L, such as above 2.4 mg/L, e.g. above 2.5 mg/L, such as above 2.7 mg/L, e.g. above 3.0 mg/L, such as above 3.5 mg/L, e.g. above 4.0 mg/L, such as in the range of 2-8 mg/L, e.g. in the range of 2.3-7.4 mg/L, such as in the range of 2.5-7.0 mg/L, e.g. in the range of 3-6 mg/L, such as in the range of 4-5 mg/L.

In yet an embodiment of the present invention the foaming aid comprises trans-5,6-Dihydroxy-1-methyl-3-(3′-4′-dihydroxyphenyl) indane and cis-5,6-Dihydroxy-1-methyl-3-(3′-4′-dihydroxyphenyl) indane. Preferably, the total concentration of trans-5,6-Dihydroxy-1-methyl-3-(3′-4′-dihydroxyphenyl) indane, cis-5,6-Dihydroxy-1-methyl-3-(3′-4′-dihydroxyphenyl) indane in the coffee product is above 2.3 mg/L, such as above 2.4 mg/L, e.g. above 2.5 mg/L, such as above 2.7 mg/L, e.g. above 3.0 mg/L, such as above 3.5 mg/L, e.g. above 4.0 mg/L, such as in the range of 2-8 mg/L, e.g. in the range of 2.3-7.4 mg/L, such as in the range of 2.5-7.0 mg/L, e.g. in the range of 3-6 mg/L, such as in the range of 4-5 mg/L.

The coffee product according to the present invention may comprise foaming aid which has been treated with an alkali. Preferably, said alkali is potassium hydroxide. Thus, the foaming aid of the present invention may be different from the other conventional products by the presence in the coffee product of or traces of said alkali, e.g. potassium hydroxide, and/or compounds from the reaction of the alkali with the 4-vinylcatechol monomers and/or the content of trans-5,6-Dihydroxy-1-methyl-3-(3′-4′-dihydroxyphenyl) indane, cis-5,6-Dihydroxy-1-methyl-3-(3′-4′-dihydroxyphenyl) indane, and/or trans-1,3-bis(3′-4′-dihydroxyphenyl)butene. Preferably, the total concentration of trans-5,6-Dihydroxy-1-methyl-3-(3′-4′-dihydroxyphenyl) indane, cis-5,6-Dihydroxy-1-methyl-3-(3′-4′-dihydroxyphenyl) indane, and/or trans-1,3-bis(3′-4′-dihydroxyphenyl)butane.

In an embodiment of the present invention the foaming aid may be packed together with a coffee extract of green coffee beans, roasted coffee beans or a mixture thereof in a container, such as a capsule.

The coffee product of the invention may typically be packed into containers such as jars, tins, bags or capsules. Thus, still another aspect of the present invention is to provide a container comprising the coffee product of the present invention. The container may be in various forms depending on the application and nature of the content. In a preferred embodiment, the container is a capsule.

It should be noted that embodiments and features described in the context of one of the aspects of the present invention also apply to the other aspects of the invention.

All patent and non-patent references cited in the present application, are hereby incorporated by reference in their entirety.

The invention will now be described in further details in the following non-limiting examples.

### EXAMPLES

### Example 1

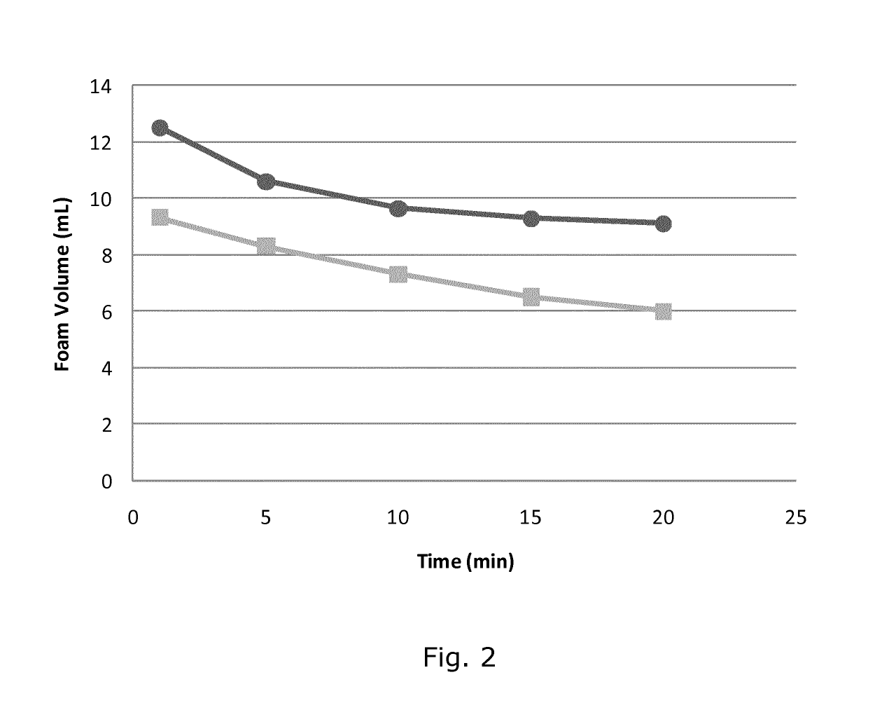

### Reconstitution of Coffee Extract Powder in the Presence of the Foaming Aid Roasted Caffeic Acid (FIG. 2)

### Preparation of the Foaming Aid Roasted Caffeic Acid.

Caffeic acid (Sigma) (1.0 g, 5.5 mmol) was roasted (16 min) in a metal crucible positioned in a lab scale oven set at 230° C. Water soluble roasted caffeic acid products were recovered using 2×50 mL of Milli-Q-grade water heated at 100° C. The newly formed solution was centrifuged (4000 rpm) and filtered. The filtered solution was separated into two aliquots. One was used as such, the other was freeze dried.

Determination of Foam Volume after Reconstitution of the Coffee Extract by Using the Foam Measuring Device (FMD).

A powdered self-foaming coffee extract (4 g) was poured into a reconstitution vessel connected to a water reservoir (FMD). The transfer of water from the reservoir to the reconstitution vessel was prevented by a valve. After reconstitution of the coffee powder with either 200 mL of water at 85° C. (control) or 200 mL of water at 85° C. containing 0.065% roasted caffeic acid (spiked), the reconstitution vessel was covered with a lid fitted with a volumetric pipette. The valve between the reconstitution vessel and the water reservoir was then opened and the water (standard tap water at room temperature) pushed the reconstituted coffee solution upwards into the pipette, allowing for an easy measurement of foam volume. Experiments were performed in duplicates.

### Results

Reconstitution of a self-foaming coffee produced according to the patent WO 2009/040249 (Nestec S.A.), in the presence of roasted caffeic acid (0.065% w/w %; the foaming aid)) boosts the production of foam as measured by FMD (FIG. 2).

FMD measures the auto-foaming performance of self-foaming coffee extract powder. This experiment confirms that in the presence of roasted caffeic acid in the reconstitution water, the auto foaming performance of the powdered coffee extract is increased.

### Example 2

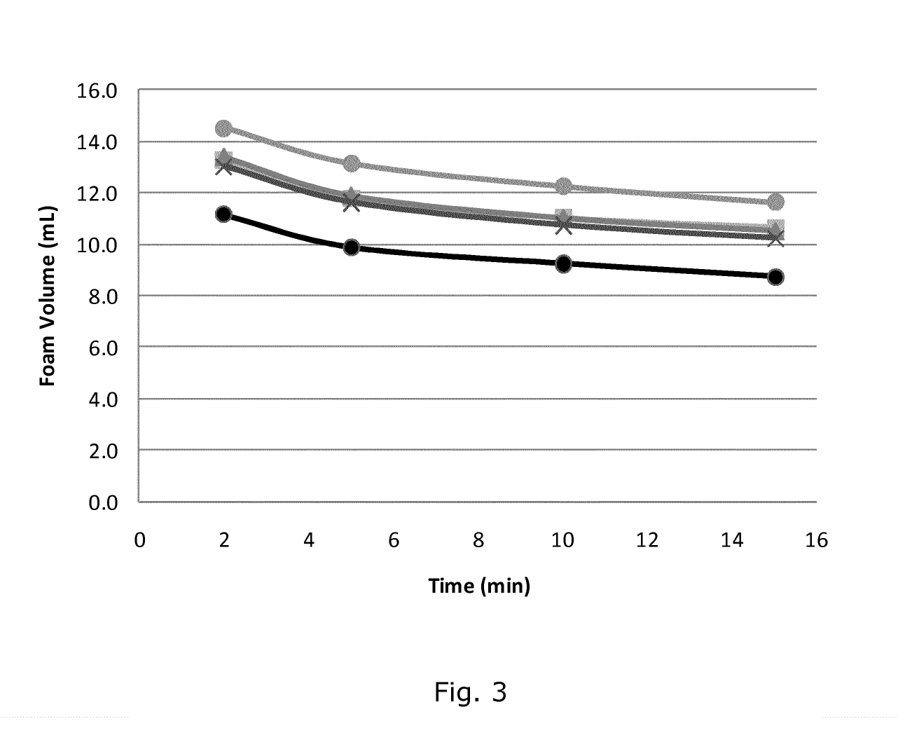

### Spiking of Green Coffee with Alkalinized Caffeic Acid (FIG. 3)

### Preparation of Spiked Green Coffee Beans.

Caffeic acid (1-8 g, 5.5-44.4 mmol) was first dissolved in alkalinized MilliQ-water (340-388 mL; potassium hydroxide (1M)). Green coffee beans (400 g) were then soaked overnight with this solution. After drying, the green beans were roasted at 236° C. for 720 s and ground using a Ditting mill set at 5.5, resulting in an average particle size of 550 μm. The ground roasted beans were used as such.

### Determination of Coffee Foam Volume by Using the Whipping Method (Ultra-Turrax).

Unspiked and respectively spiked roasted and ground coffee samples were suspended in water (2.7 g in 50 mL water at 60° C.) poured in a graduated cylinder (height: 20.8 cm, internal diameter: 26 mm) and whipped at 15000 rpm for 5 s using a T 25 digital Ultra-Turrax with the dispersing tool S 25 N-18G (IKA, Staufen, Germany). The foamability was quantified by measuring the foam volume after two minutes. To evaluate the foam stability, the foam volume was also measured after 5, 10 and 15 minutes. Experiments were performed in duplicates.

### Results

Enrichment of green coffee beans with different amounts of caffeic acid as described above generated coffee samples with increased foam volumes (FIG. 3). Foam volumes versus time (Arabica): unspiked (black circles) and spiked with caffeic acid (0.25% caffeic acid (dark grey crosses); 0.5% caffeic acid (light grey triangles); 1% caffeic acid (light grey squares) and 2% caffeic acid (light grey circles).

### Example 3

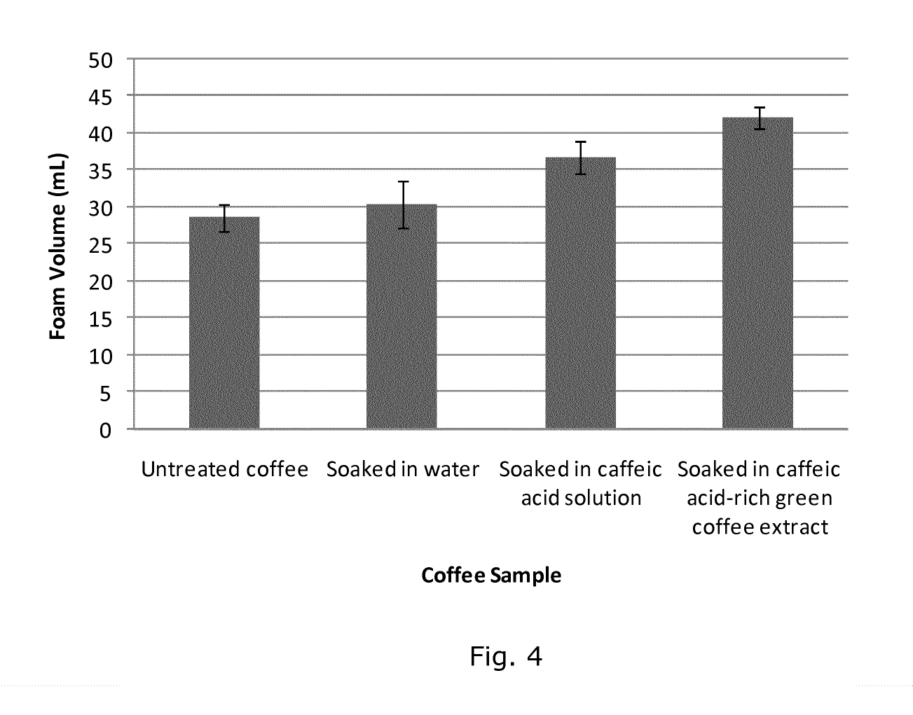

### Soaking of Green Coffee with a Caffeic Acid Enriched Green Coffee Extract, with Water and with Caffeic Acid (FIG. 4)

One batch of green coffee beans was separated into 3 lots of 500 g. One lot was soaked overnight with a caffeic acid enriched green coffee extract (500 g, TC 2%) produced following the procedure described in WOLA1 ESTERASE. The second lot was soaked overnight in water (500 mL) and the third lot was soaked overnight in a caffeic acid solution (600 mg, 3.33 mmol, 500 mL). After drying, all the beans were roasted at 236° C. for 550 s. The beans were ground using a Ditting mill set at 5.5, resulting in a particle size of 550 μm. The ground beans were extracted by applying a two-step extraction procedure (100° C./10 min and 180° C./10 min) using a Dionex ASE 200. The resulting extracts were collected and freeze dried.

### Determination of Coffee Foam Volumes by Using the KOMO Machine

The roasted coffee extracts from above were dissolved in MilliQ water (75° C.) at a TC 2%. 83 mL of each sample solution was passed through a whipping device (15000 rpm for 20 s) and the foamed liquid was recovered in a volumetric cylinder. The foam volume was recorded every 30 s up to 360 s. The initial foam volumes and foam decay rates (0-120 s) were extrapolated from the foam curve using a logarithmic model.

From this method the enrichment of green coffee beans with caffeic acid using green coffee extracts enriched in caffeic acid as a carrier and as described above generated coffee samples with increased foamability (FIG. 4).

### REFERENCES

### EP 0 839 457

WO 2009/040249

1. A process of making a foaming aid comprising the steps of
(i) providing a composition comprising at least two 4-vinylcatechol monomers; and
(ii) inducing polymerization of the 4-vinylcatechol monomers of step (i) to obtain a composition comprising polyfunctional phenols.

2. The process according to claim 1, wherein the polymerization in step (ii) is induced by heat treatment.

3. The process according to claim 1 comprising the step of treating the composition comprising polyfunctional phenols of step (ii) with an alkali.

4. A foaming aid obtainable by the process according to claim 1.

5. A method of producing a coffee beverage comprising the steps of:
(i) providing a composition comprising at least two 4-vinylcatechol monomers; and
(ii) inducing polymerization of the 4-vinylcatechol monomers of step (i) to obtain a composition comprising polyfunctional phenols and using the foaming aid to produce a beverage.

6. A process of making a coffee product comprising the steps of:
(a) providing a coffee extract; and
(b) adding a foaming aid produced by the steps of providing a composition comprising at least two 4-vinylcatechol monomers; and inducing polymerization of the 4-vinylcatechol monomers of step (i) to obtain a composition comprising polyfunctional phenols to the extract.

7. The process according to claim 6, wherein the foaming aid is added prior to drying the coffee extract.

8. The process according to claim 6, wherein the foaming aid is added after drying the coffee extract.

9. The process according to claim 6, wherein the coffee extract is an extract selected from the group consisting of green coffee beans, roasted coffee beans and mixtures thereof.

10. The process according to claim 6, wherein the coffee product is a coffee product selected from the group consisting of instant coffee, instant espresso coffee, liquid coffee concentrate and coffee mixes, coffee mixtures, R&G coffee with or without capsules, mixes of R&G and instant coffee, ready-to-drink coffee beverages,

11. A coffee product comprising a foaming agent produced by the steps of
(i) providing a composition comprising at least two 4-vinylcatechol monomers; and
(ii) inducing polymerization of the 4-vinylcatechol monomers of step (i) to obtain a composition comprising polyfunctional phenols and adding the composition to a coffee.

12. The coffee product according the claim 11, where the total concentration of trans-5,6-Dihydroxy-1-methyl-3-(3′-4′-dihydroxyphenyl) indane, cis-5,6-Dihydroxy-1-methyl-3-(3′-4′-dihydroxyphenyl) indane, and/or trans-1,3-bis(3′-4′-dihydroxyphenyl)butane in the product is above 2.3 mg/L.

13. The coffee product according to claim 12, where the total concentration of trans-5,6-Dihydroxy-1-methyl-3-(3′-4′-dihydroxyphenyl) indane, cis-5,6-Dihydroxy-1-methyl-3-(3′-4′-dihydroxyphenyl) indane in the product is above 2.3 mg/L.

14. A container comprising a coffee product comprising a foaming agent produced by the steps of (i) providing a composition comprising at least two 4-vinylcatechol monomers; and (ii) inducing polymerization of the 4-vinylcatechol monomers of step (i) to obtain a composition comprising polyfunctional phenols.

15. The container of claim 14, where the container is a capsule.
